(19) United States
(12) Patent Application Publication
(10) Pub. No.: US 2010/0013413 A1
(43) Pub. Date: Jan. 21, 2010

(54) Light Emitting Device

(76) Inventors: Jen-Chieh Hu, Kaohsiung County (TW); Wei-Ta Chiu, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/326,084

(22) Filed: Dec. 1, 2008

(30) Foreign Application Priority Data
Jul. 15, 2008 (TW) 097126764

(51) Int. Cl. H05B 37/02

(52) U.S. Cl. 315/297

(57) ABSTRACT

A light emitting device capable of decreasing manufacturing cost includes a power generator for generating a first DC power, a first DC controller for generating a control signal, a DC-DC transformer coupled to the power generator and the DC control unit, for transforming the first DC power into a second DC power according to the control signal, a plurality of LED loads each including a plurality of LED sequences coupled to the DC-DC transformer, for emitting light according to the second DC power, and a plurality of LED drivers coupled to the plurality of LED loads, for adjusting output currents of the LED sequences to achieve constant output currents.

### BACKGROUND OF THE INVENTION

1. Field of the Invention

The present invention is related to a light emitting device, and more particularly, to a light emitting device capable of decreasing manufacturing cost.

2. Description of the Prior Art

Recently, application fields of light emitting diodes (LEDs) are widely developed. Different from an incandescent lamp, LED emits luminescence light, and has advantages of low power consumption, long life, short warming time and rapid response. Moreover, since LED is small, shake-proof, easily produced and can be manufactured into a tiny or arrayed element in confirmation with different requirements, LED is widely applied in an indicator light or a display device in information, communication or consuming electronic products. LED can be applied not only in outdoor monitors and traffic lights but also in all kinds of portable products, e.g. backlight of mobile phones or personal digital assistants, especially liquid crystal displays.

Please refer to FIG. 1, which illustrates a schematic diagram of a light emitting device 10 in the prior art. The light emitting 10 includes a power generator 100, LED loads LED_LD_1˜LED_LD_n, DC-DC (direct-current to direct-current) transformers DCT_1˜DCT_n, LED drivers LED_DRV_1˜LED_DRV_n, and DC control units DC_CTR_1˜DC_CTR_n. The LED loads LED_LD_1˜LED_LD_n are respectively composed of “m” parallel LED sequences, and each LED sequence includes a plurality of LEDs. In the light emitting device 10, the DC control units DC_CTR_1˜DC_CTR_n control the DC-DC transformers DCT_1˜DCT_n to transform power generated by the power generator 100 appropriately, to drive the LED loads LED_LD_1˜LED_LD_n. The LED drivers LED_DRV_1˜LED_DRV_n can adjust output currents OUT1˜OUTm of the LED sequences, so as to achieve constant current control, and emit stable light source.

The light emitting device 10 can achieve constant current control. However, each LED load needs a DC-DC transformer, which increases the manufacturing cost, and limits the application range.

### SUMMARY OF THE INVENTION

It is therefore an objective of the present invention to provide a light emitting device capable of decreasing manufacturing cost.

According to the present invention, a light emitting device capable of decreasing manufacturing cost comprises a power generator for generating a first DC power, a first DC controller for generating a control signal, a DC-DC transformer coupled to the power generator and the DC control unit, for transforming the first DC power into a second DC power according to the control signal, a plurality of LED loads each comprising a plurality of LED sequences coupled to the DC-DC transformer, for emitting light according to the second DC power, and a plurality of LED drivers coupled to the plurality of LED loads, for adjusting output currents of the LED sequences to achieve constant output currents.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a light emitting device in the prior art.

FIG. 2 illustrates a schematic diagram of a light emitting device capable of decreasing manufacturing cost according to an embodiment of the present invention.

FIG. 3 illustrates a schematic diagram of a light emitting device capable of decreasing manufacturing cost according to an embodiment of the present invention.

FIG. 3 illustrates a schematic diagram of the light emitting device shown in FIG. 4 with a voltage drop generator.

### DETAILED DESCRIPTION

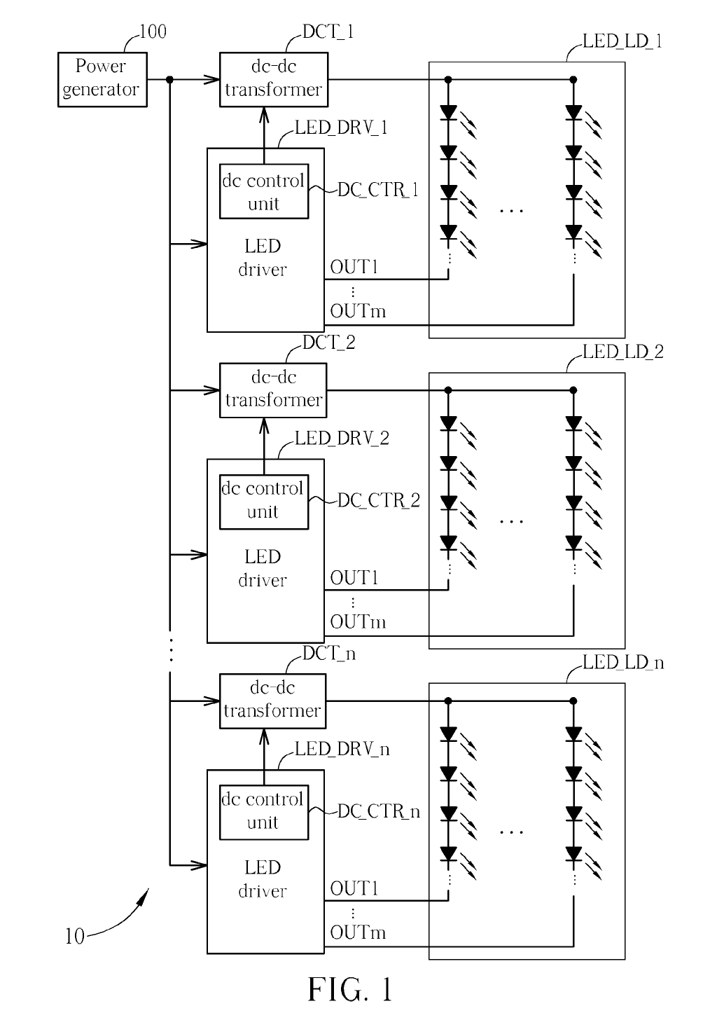

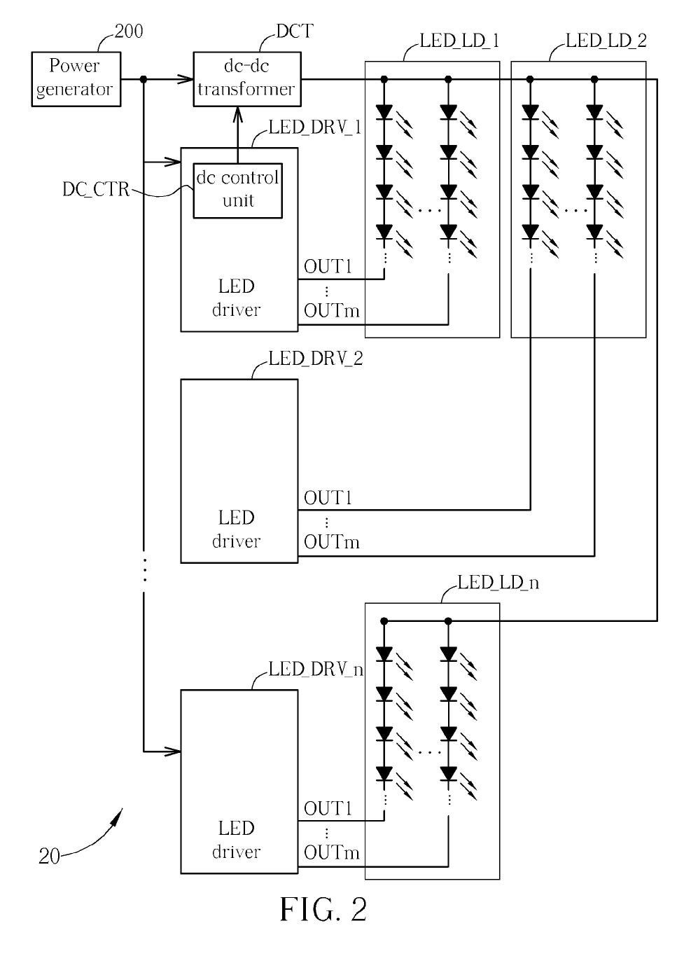

Please refer to FIG. 2, which illustrates a schematic diagram of a light emitting device 20 according to an embodiment of the present invention. The light emitting device 20 can decrease manufacturing cost, and comprises a power generator 200, a first DC controller DC_CTR, a DC-DC transformer DCT, LED loads LE_LD_1˜LED_LD_n, and LED drivers LED_DRV_1˜LED_DRV_{—n.} The first DC controller DC-CTR generates a control signal to control the DC-DC transformer DCT to transform DC power generated by the power generator 200 for the LED loads LED_LD_1˜LED_LD_n. Operations of the LED loads LED_LD_1˜LED_LD_n and the LED drivers LED_DRV_1˜LED_DRV_n are similar to those in the light emitting device 10 shown in FIG. 1, and will not be narrated for clarity.

As shown in FIG. 2, the light emitting device 20 uses the single DC-DC transformer DCT to drive the LED loads LED_LD_1˜LED_LD_n to emit light. In such situation, the light emitting device 20 can achieve constant current control, and correspondingly, the manufacturing or production cost can be decreased.

In FIG. 2, the first DC controller DC_CTR is integrated into the LED driver LED_DRV_1, to control operations of the DC-DC transformer DCT. In fact, the first DC controller DC_CTR can be installed outside the LED drivers LED_DRV_1˜LED_DRV_n. Alternatively, for facilitating the manufacturing process, each of the LED drivers LED_DRV_1˜LED_DRV_n can include the DC control units and a control unit, and the control unit is utilized for switching the DC control unit.

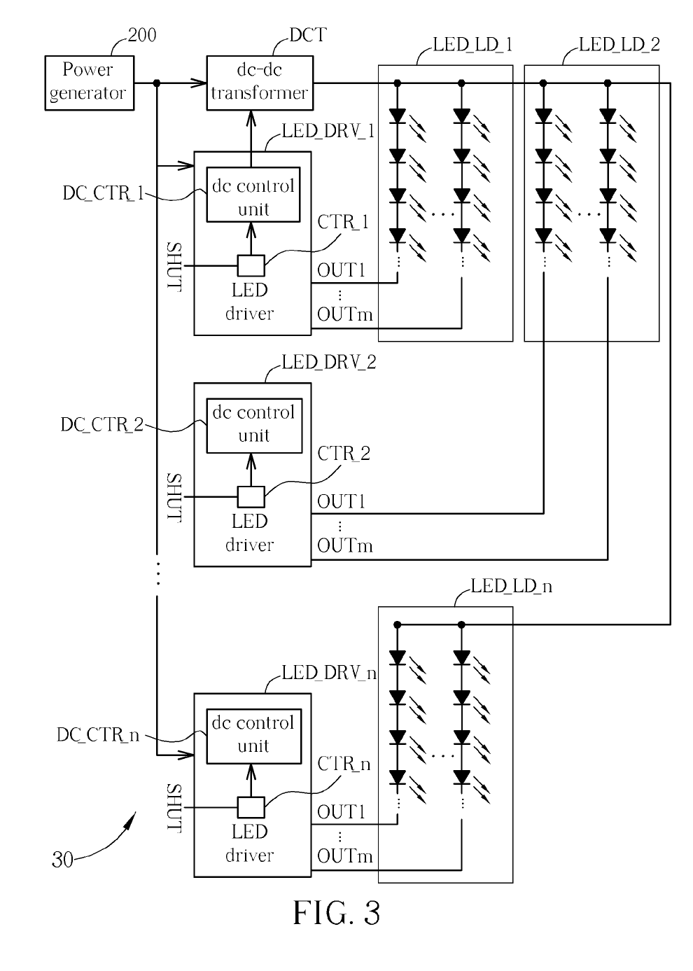

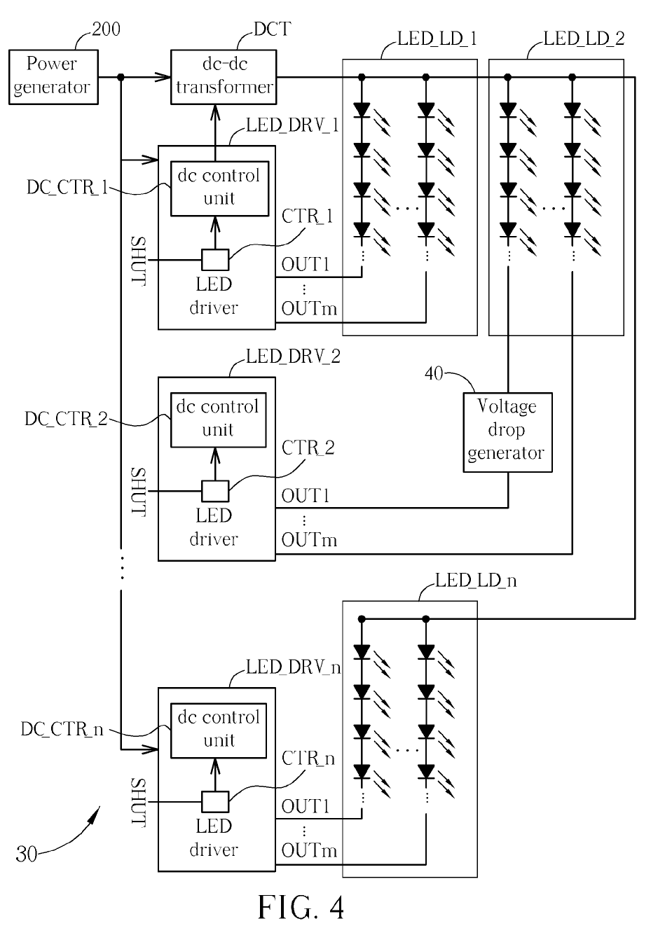

Please refer to FIG. 3, which illustrates a light emitting device 30 capable of decreasing manufacturing cost according to an embodiment of the present invention. The structure of the light emitting device 30 is similar to that of the light emitting device 20, while the difference is: in the light emitting device 30, the LED drivers LED_DRV_1˜LED_DRV_n includes DC control units DC_CTR_1˜DC_CTR_n and control units CTR_1˜CTR_n. The control units CTR_1˜CTR_n switch the DC control units DC_CTR_1˜DC_CTR_n according to a shutdown signal SHUT. In other words, when manufacturing the light emitting device 30, there is no need to manufacture a unique DC control unit DC_CTR_1, but to manufacture the DC control units DC_CTR_1˜DC_CTR_n by the same process. In such situation, the light emitting device 30 can turn off the DC control units DC_CTR_2˜DC_CTR_n via the control units CTR_2˜CTR_n, to achieve the same effect of the light emitting device 20 shown in FIG. 2.

In FIG. 3, the light emitting device 30 can drive the LED loads LED_LD_1˜LED_LD_n to emit light via the single DC-DC transformer DCT, and switch the DC control units DC_CTR_1˜DC_CTR_n via the shutdown signal SHUT. As a result, the light emitting device 30 can achieve constant current control with decreased cost. More important, when manufacturing the light emitting device 30, there is no need to manufacture a unique DC control unit DC_CTR_1, while the light emitting device 30 can turn off the DC control units DC_CTR_2˜DC_CTR_n via the control units CTR_2˜CTR_n, to achieve the same effect of the light emitting device 20 shown in FIG. 2.

In addition, when a forward voltage drop of an LED sequence is smaller than forward voltage drops of other LED sequences, the power consumption of the LED driver is increased, and may cause overheated risk. In such situation, the present invention can use a voltage drop generator to improve the risk. For example, in FIG. 4, if the forward voltage drop of the first LED sequence within the LED load LED_LD_2 is smaller than other LED sequences, the present invention can add a voltage drop generator 40, to decrease output voltage of an output current route OUT1 of the LED driver LED_DRV_2, so as to decrease power consumption of the LED driver LED_DRV_2, and prevent overheated risk. The voltage drop generator 40 can be any element for generating voltage drop, such as resistor.

In summary, the present invention can drive all the LED loads to emit light via the single DC-DC transformer, to achieve constant current control with decreased cost.

Those skilled in the art will readily observe that numerous modifications and alterations of the device and method may be made while retaining the teachings of the invention.

What is claimed is:

1. A light emitting device comprising:
a power generator for generating a first direct-current (DC) power;
a first DC controller for generating a control signal;
a DC to DC (DC-DC) transformer coupled to the power generator and the DC control unit, for transforming the first DC power into a second DC power according to the control signal;
a plurality of light emitting diode (LED) loads each comprising a plurality of LED sequences coupled to the DC-DC transformer, for emitting light according to the second DC power; and
a plurality of LED drivers coupled to the plurality of LED loads, for adjusting output currents of the LED sequences to achieve constant output currents.

2. The light emitting device of claim 1, wherein the first DC controller is integrated into a first LED driver of the plurality of LED drivers.

3. The light emitting device of claim 2, wherein each of LED drivers different from the first LED driver within the plurality of LED drivers comprises a second DC control unit and a control unit, and the control unit is utilized for turning off operation of the second DC control unit.

4. The light emitting device of claim 3, wherein the second DC control unit is identical to the first DC controller.

5. The light emitting device of claim 1 further comprising a voltage drop generator coupled between a first LED sequence of a first LED load within the plurality of LED loads and a first LED driver within the plurality of LED drivers, for generating a voltage drop.

6. The light emitting device of claim 5, wherein a forward voltage drop of the first LED sequence is smaller than that of at lease one LED sequence with the first LED load.

7. The light emitting device of claim 5, wherein the voltage drop generator is a resistor.

8. The light emitting device of claim 1, wherein each of the plurality of LED sequences comprises a plurality of LEDs in a sequence.
